(19) United States
(12) Patent Application Publication
(10) Pub. No.: US 2025/0238278 A1
(43) Pub. Date: Jul. 24, 2025

(54) METHOD AND SYSTEM FOR CO-ALLOCATING REGISTERS AND LOCAL DATA STORAGE

(71) Applicant: Samsung Electronics Co., Ltd., Gyeonggi-do (KR)

(72) Inventors: Timothy KONG, San Jose, CA (US); Wilson FUNG, Milpitas, CA (US)

(21) Appl. No.: 18/644,389

(22) Filed: Apr. 24, 2024

Related U.S. Application Data
(60) Provisional application No. 63/623,059, filed on Jan. 19, 2024.

(51) Int. Cl. G06F 9/50

(52) U.S. Cl. CPC G06F 9/5055; G06F 9/5016

(57) ABSTRACT

A method and device are provided in which a graphics processing unit (GPU) processor determines an upper threshold number of concurrent program instances and a lower threshold number of concurrent program instances for the GPU processor based on a number of allocations for program variables, a total number of registers of the GPU, and a total number of memory locations of the GPU. The GPU processor also determines, for the GPU processor, a number of concurrent program instances between the upper threshold number and the lower threshold number, inclusive, that completes allocations for the program variables with corresponding registers and memory locations per program instance.

### PRIORITY

This application is based on and claims priority under 35 U.S.C. § 119 (e) to U.S. Provisional Patent Application Ser. No. 63/623,059, which was filed in the U.S. Patent and Trademark Office on Jan. 19, 2024, the entire content of which is incorporated herein by reference.

### TECHNICAL FIELD

The present disclosure relates generally to, and more particularly, to a system and method.

### SUMMARY

Modern graphics processing unit (GPU) architectures include shader processors, which are short programs that render graphics data. Each shader processor multiplexes the execution of multiple single instruction/multiple data (SIMD) threads (e.g., waves) to maximize arithmetic-logic unit (ALU) utilization. The multiplexed execution allows the shader processor to tolerate operational pipeline and memory latency of each wave by keeping the ALU busy with works from other waves while a subset of waves is waiting for the completion of long latency operations (e.g., memory access operations).

In order to tolerate a long latency that may reach hundreds of cycles, each shader processor may be designed to sustain a high number of waves (e.g., more than 10 waves). These waves share a common pool of register file storage, which is managed by a hardware (HW) register allocator that throttles the number of waves based on a peak register footprint required by each wave. This peak register footprint of a wave is a function of a shader program that the wave is assigned to execute. A GPU shader compiler determines the register footprint required by a shader program via the register allocator that assigns logical registers exposed by an instruction set architecture (ISA) to program variables.

The number of waves that the shader processor can sustain in-flight with its limited resource is referred to as “wave occupancy”. The higher the wave occupancy, the better the shader processor's ability to tolerate long latency operation and to maintain high ALU utilization. As a result, maintaining the highest wave occupancy possible for a given shader program is important to overall GPU shader processor throughput.

In some GPU designs, waves on a fixed set of shader processors also share a common on-chip fixed sized memory for fast communication between waves, which may be referred to as the local data store. Depending on the application, this local data store may be underutilized. It may be possible to improve overall wave occupancy by spilling (or moving) program variables from different waves to this local data store if there are more program variables than logical registers.

A register allocator may generate spill instructions to move variables assuming a fixed number of registers and a fixed memory size, which may be limitless. However, optimization objectives of the register allocator may include maximizing code performance by reducing dynamic spill instructions, and minimizing a program footprint by reducing static spill instructions at the expense of less instruction-level parallelism.

One issue with the above approach is that the register footprint and the spill memory footprint are not optimized together. There is no reason to use fewer registers as unused registers may be considered wasted. Such register allocators are designed to optimize a single program instance and are not designed to maximize wave occupancy. For example, such registers do not consider the total capacity of the registers and the spill memory for a maximized number of program instances.

To overcome these issues, methods and devices are provided to perform register and local data store co-allocation. This approach improves on previous methods in that variables are intentionally spilled in order to reduce a program's register footprint to improve wave occupancy.

In an embodiment, a method is provided in which a GPU processor determines an upper threshold number of concurrent program instances and a lower threshold number of concurrent program instances for the GPU processor based on a number of allocations for program variables, a total number of registers of the GPU, and a total number of memory locations of the GPU. The GPU processor also determines, for the GPU processor, a number of concurrent program instances between the upper threshold number and the lower threshold number, inclusive, that completes allocations for the program variables with corresponding registers and memory locations for a program instance.

In an embodiment, a GPU is provided that includes a plurality of registers, a memory store including a plurality of memory locations, and a processor. The processor is configured to determine an upper threshold number of concurrent program instances and a lower threshold number of concurrent program instances for the GPU processor based on a number of allocations for program variables, a total number of the plurality of registers, and a total number of the plurality of memory locations. The processor is also configured to determine, for the GPU processor, a number of concurrent program instances between the upper threshold number and the lower threshold number, inclusive, that completes allocations for the program variables with corresponding registers and memory locations for a program instance.

In an embodiment, a user equipment (UE) is provided that includes a processor and a non-transitory computer readable storage medium storing instructions. When executed, the instructions cause the processor to determine an upper threshold number of concurrent program instances and a lower threshold number of concurrent program instances for the processor based on a number of allocations for program variables, a total number of registers of a GPU, and a total number of memory locations of the GPU. The instructions also cause the processor to determine, for the processor, a number of concurrent program instances between the upper threshold number and the lower threshold number, inclusive, that completes allocations for the program variables with corresponding registers and memory locations per program instance.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 is a diagram illustrating an electronic device, according to an embodiment;

FIG. 2 is a flowchart illustrating a method for determining a wave occupancy, according to an embodiment; and

FIG. 3 is a block diagram illustrating of an electronic device in a network environment, according to an embodiment.

### DETAILED DESCRIPTION

Hereinafter, various embodiments of the disclosure are described in detail with reference to the accompanying drawings. The same elements may be designated by the same or similar reference numerals although they are shown in different drawings.

In the following description, specific details such as detailed configurations and components are merely provided to assist with the overall understanding of the embodiments of the present disclosure. Therefore, it should be apparent to those skilled in the art that various changes and modifications of the embodiments described herein may be made without departing from the scope of the present disclosure.

In addition, descriptions of well-known functions and constructions are omitted for clarity and conciseness.

The terms described below are terms defined in consideration of the functions in the present disclosure, and may be different according to users, intentions of the users, or customs. Therefore, the definitions of the terms should be determined based on the contents throughout this specification.

The present disclosure may have various modifications and various embodiments, among which embodiments are described below in detail with reference to the accompanying drawings. However, it should be understood that the present disclosure is not limited to the embodiments, but includes all modifications, equivalents, and alternatives within the scope of the present disclosure.

Although the terms including an ordinal number such as first, second, etc. may be used for describing various elements, the structural elements are not restricted by the terms. The terms are only used to distinguish one element from another element. For example, without departing from the scope of the present disclosure, a first structural element may be referred to as a second structural element. Similarly, the second structural element may also be referred to as the first structural element. As used herein, the term “and/or” includes any and all combinations of one or more associated items. Additionally, singular forms are intended to include plural forms unless the context clearly indicates otherwise.

As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, terms such as “1^{st},” “2^{nd},” “first,” and “second” may be used to distinguish a corresponding component from another component but are not intended to limit the components in other aspects (e.g., importance or order).

If an element (e.g., a first element) is referred to, with or without the term “operatively” or “communicatively”, as “coupled with,” “coupled to,” “connected with,” or “connected to” another element (e.g., a second element), it indicates that the element may be coupled with the other element directly (e.g., wired), wirelessly, or via a third element.

The terms used herein are merely used to describe various embodiments of the present disclosure but are not intended to limit the present disclosure. In the present disclosure, the terms “include” or “have” indicate existence of a feature, a number, a step, an operation, a structural element, parts, or a combination thereof, and do not exclude the existence or probability of the addition of one or more other features, numerals, steps, operations, structural elements, parts, or combinations thereof.

Unless defined differently, all terms used herein have the same meanings as those understood by a person skilled in the art to which the present disclosure belongs. Terms such as those defined in a generally used dictionary are to be interpreted to have the same meanings as the contextual meanings in the relevant field of art and are not to be interpreted to have ideal or excessively formal meanings unless clearly defined in the present disclosure.

An electronic device may be one of various types of electronic devices utilizing storage devices. The electronic device may use any suitable storage standard, such as, e.g., peripheral component interconnect express (PCIe), nonvolatile memory express (NVMe), NVMe-over-fabric (NVMeoF), advanced extensible interface (AXI), ultra-path interconnect (UPI), ethernet, transmission control protocol/Internet protocol (TCP/IP), remote direct memory access (RDMA), RDMA over converged ethernet (ROCE), fibre channel (FC), infiniband (IB), serial advanced technology attachment (SATA), small computer systems interface (SCSI), serial attached SCSI (SAS), Internet wide-area RDMA protocol (iWARP), etc., or any combination thereof. In some embodiments, an interconnect interface may be implemented with one or more memory semantic and/or memory coherent interfaces and/or protocols including one or more compute express link (CXL) protocols such as CXL.mem, CXL.io, and/or CXL.cache, Gen-Z, coherent accelerator processor interface (CAPI), cache coherent interconnect for accelerators (CCIX), etc., or any combination thereof. Any of the memory devices may be implemented with one or more of any type of memory device interface including double data rate (DDR), DDR2, DDR3, DDR4, DDR5, low-power DDR (LPDDRX), open memory interface (OMI), NVlink high bandwidth memory (HBM), HBM2, HBM3, and/or the like. The electronic devices may include, e.g., a portable communication device (e.g., a smart phone), a computer, a portable multimedia device, a portable medical device, a camera, a wearable device, or a home appliance. However, an electronic device is not limited to those described above.

As used herein, the term “module” may include a unit implemented in hardware, software, firmware, or combination thereof, and may interchangeably be used with other terms, for example, “logic,” “logic block,” “part,” and “circuitry.” A module may be a single integral component, or a minimum unit or part thereof, adapted to perform one or more functions. For example, according to one embodiment, a module may be implemented in a form of an application-specific integrated circuit (ASIC), a co-processor, or field programmable gate arrays (FPGAs).

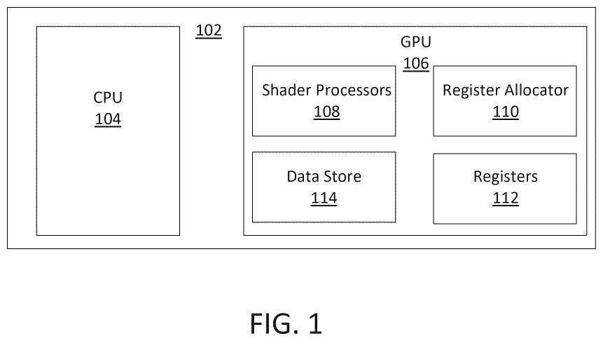

FIG. 1 is a diagram illustrating an electronic device, according to an embodiment. An electronic device 102 may include a central processing unit (CPU) 104 and a GPU 106. The GPU 106 may include one or more shader processors 108.

In rendering graphics data, a GPU shader processor 108 may utilize a register allocator 110 to assign registers 112 for program variables. The process of assigning the registers 112 may be referred to as coloring.

Coloring may be performed by building and analyzing an explicit interference graph. Nodes in the graph represent program variables, and edges in graph connect nodes whose variables cannot be assigned to the same register. Coloring may also be performed by a linear scan having instructions along program execution paths. Free registers may be assigned to instruction operands and registers no longer in use by any instruction may be released. Coloring may also be performed by interference via single-static assignment (SSA). A compiler's SSA intermediate representation may be directly used to discover interference among program variables. No explicit interference graph is built.

Concurrent program instances or waves may share a common on-chip fixed sized memory referred to as a local data store 114. Instead of allocating some program variables to the registers 112, they may be intentionally spilled to the local data store 114 in order to reduce a program's register footprint and to improve wave occupancy.

According to an embodiment, register allocation may be adapted to determine a number of concurrent program instances (e.g., wave occupancy), the number of registers allotted to each program instance, and/or a size of the spill memory allotted to each program instance. Registers may be allocated while simultaneously determining the number of concurrent program instances, which affects the number of registers available to the register allocator.

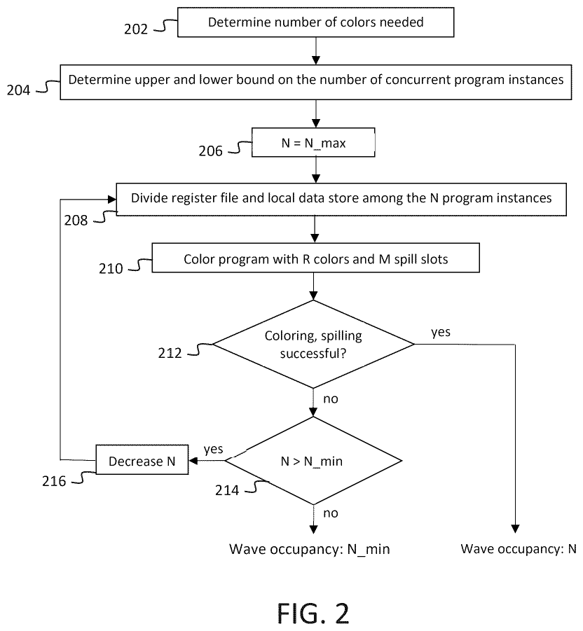

FIG. 2 is a flowchart illustrating a method for determining a wave occupancy, according to an embodiment. At 202, coloring may be initially performed, with no limit on the number of registers available, in order to determine a number of colors C needed for successful coloring. As described above coloring refers to the allocation of registers to program variables. At 204, an upper and lower bound on the number of concurrent program instances N is determined. An upper bound of N, which defines the largest number of program instances that can fit into the registers and memory, may be determined by Equation (1) below:

$$N\_max = ( R\_total + M\_total ) / C \qquad ( 1 )$$

where R_total is the total register file size in terms of number of registers, and M_total is the total memory size in terms of spill locations. A lower bound of N may be determined by Equation (2) below:

$$N\_min = R\_total / C \qquad ( 2 )$$

At 206, the number of concurrent program instances N may be set to the upper bound N_max. At 208, a register file and local data store are divided among the program instances in accordance with Equations (3) and (4) below:

$$R = R\_total / N \qquad ( 3 )$$

$$M = M\_total / N \qquad ( 4 )$$

where R is the number of registers allotted to each program instance, and M is the number of spill memory locations allotted to each program instance.

At 210, a program may be re-colored with R colors, and spill may be allotted to M spill memory locations. At 212, it may be determined whether coloring and spilling is successful. If it is determined that the coloring and spilling is successful, the wave occupancy may be determined as the current value of instances N, along with the corresponding allocation/spill solution. If it is determined that coloring and spilling is not successful, it may be determined whether N is greater than the lower bound N_min, at 214.

If N is greater than the lower bound N_min, N may be decreased to a next highest wave count that makes more register/memory available to the shared program (e.g., per GPU hardware constraints), at 216, and the methodology may return to 208 to divide the register file and the local data store among the new value of program instances. If N is not greater than the lower bound N_min, the wave occupancy may be determined to be the lower bound of instances N_min, along with the corresponding allocation/spill solution.

At step 216, N may be decremented by one. In an alternative embodiment, N may be decreased to a next highest allowable value. The number of concurrent program instances (wave count) N may be limited to a set of allowable values due to hardware restrictions (e.g., GPU hardware restrictions). For example, the GPU hardware may allocate registers to shader programs in chunks, with all program instances receiving the same number of chunks. To increase the number of concurrent program instances N, the number of chunks allocated to the program may be reduced. In such a case, decreasing the chunk allocation by one may increase the number of concurrent program instances by more than one, because enough chunks have been freed up to fit more than one extra program instance. Thus, the useful wave count is quantized.

In addition to the wave count being quantized by the chunking of the register file, the wave count may also be quantized by the chunking of the on-chip memory (local data store). The hardware may allocate memory locations to program instances in chunks, where each chunk contains the same number of memory locations. Accordingly, embodiments may include register chunking, memory chunking, neither, or both.

A variety of coloring algorithms may be applied at 202 and 210. The same coloring algorithm may be used at 202 and 210, or different coloring algorithms may be used at each of 202 and 210.

At 202, instead of performing a full coloring to compute an exact number of colors needed, a faster procedure may be executed to estimate the number of colors that are needed for successful coloring. At 210, instead of re-coloring, colors may be removed from the color solution produced at 202 until no more than R registers are used, and the variable may be spilled to the memory as its color is removed.

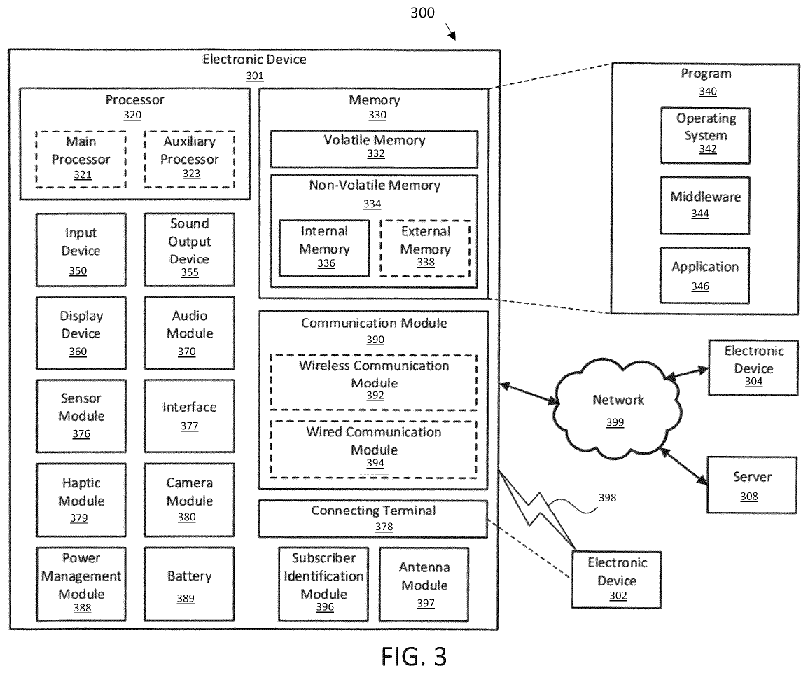

FIG. 3 illustrates an electronic device in a network environment, according to an embodiment.

Referring to FIG. 3, the electronic device 301, e.g., a mobile terminal including GPS functionality, in the network environment 300 may communicate with an electronic device 302 via a first network 398 (e.g., a short-range wireless communication network), or an electronic device 304 or a server 308 via a second network 399 (e.g., a long-range wireless communication network). The electronic device 301 may communicate with the electronic device 304 via the server 308. The electronic device 301 may include a processor 320, a memory 330, an input device 350, a sound output device 355, a display device 360, an audio module 370, a sensor module 376, an interface 377, a haptic module 379, a camera module 380, a power management module 388, a battery 389, a communication module 390, a subscriber identification module (SIM) 396, or an antenna module 397 including a global navigation satellite system (GNSS) antenna. In one embodiment, at least one (e.g., the display device 360 or the camera module 380) of the components may be omitted from the electronic device 301, or one or more other components may be added to the electronic device 301. In one embodiment, some of the components may be implemented as a single integrated circuit (IC). For example, the sensor module 376 (e.g., a fingerprint sensor, an iris sensor, or an illuminance sensor) may be embedded in the display device 360 (e.g., a display).

The processor 320 may execute, for example, software (e.g., a program 340) to control at least one other component (e.g., a hardware or a software component) of the electronic device 301 coupled with the processor 320 and may perform various data processing or computations.

As at least part of the data processing or computations, the processor 320 may load a command or data received from another component (e.g., the sensor module 376 or the communication module 390) in volatile memory 332, process the command or the data stored in the volatile memory 332, and store resulting data in non-volatile memory 334. The processor 320 may include a main processor 321 (e.g., a CPU or an application processor, and an auxiliary processor 323 (e.g., a graphics processing unit (GPU), an image signal processor (ISP), a sensor hub processor, or a communication processor (CP)) that is operable independently from, or in conjunction with, the main processor 321. Additionally or alternatively, the auxiliary processor 323 may be adapted to consume less power than the main processor 321 or execute a particular function. The auxiliary processor 323 may be implemented as being separate from, or a part of, the main processor 321.

The auxiliary processor 323 may control at least some of the functions or states related to at least one component (e.g., the display device 360, the sensor module 376, or the communication module 390) among the components of the electronic device 301, instead of the main processor 321 while the main processor 321 is in an inactive (e.g., sleep) state, or together with the main processor 321 while the main processor 321 is in an active state (e.g., executing an application). According to one embodiment, the auxiliary processor 323 (e.g., an ISP or a CP) may be implemented as part of another component (e.g., the camera module 380 or the communication module 390) functionally related to the auxiliary processor 323.

The memory 330, e.g., a memory device as illustrated in FIG. 2, may store various data used by at least one component (e.g., the processor 320 or the sensor module 376) of the electronic device 301. The various data may include, for example, software (e.g., the program 340) and input data or output data for a command related thereto. The memory 330 may include the volatile memory 332 or the non-volatile memory 334.

The program 340 may be stored in the memory 330 as software, and may include, for example, an operating system (OS) 342, middleware 344, or an application 346.

The input device 350 may receive a command or data to be used by other component (e.g., the processor 320) of the electronic device 301, from the outside (e.g., a user) of the electronic device 301. The input device 350 may include, for example, a microphone, a mouse, or a keyboard.

The sound output device 355 may output sound signals to the outside of the electronic device 301. The sound output device 355 may include, for example, a speaker or a receiver. The speaker may be used for general purposes, such as playing multimedia or recording, and the receiver may be used for receiving an incoming call. According to one embodiment, the receiver may be implemented as being separate from, or a part of, the speaker.

The display device 360 may visually provide information to the outside (e.g., a user) of the electronic device 301. The display device 360 may include, for example, a display, a hologram device, or a projector and control circuitry to control a corresponding one of the display, hologram device, and projector. According to one embodiment, the display device 360 may include touch circuitry adapted to detect a touch, or sensor circuitry (e.g., a pressure sensor) adapted to measure the intensity of force incurred by the touch.

The audio module 370 may convert a sound into an electrical signal and vice versa. According to one embodiment, the audio module 370 may obtain the sound via the input device 350, or output the sound via the sound output device 355 or a headphone of an external electronic device 302 directly (e.g., wiredly) or wirelessly coupled with the electronic device 301.

The sensor module 376 may detect an operational state (e.g., power or temperature) of the electronic device 301 or an environmental state (e.g., a state of a user) external to the electronic device 301, and then generate an electrical signal or data value corresponding to the detected state. The sensor module 376 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 377 may support one or more specified protocols to be used for the electronic device 301 to be coupled with the external electronic device 302 directly (e.g., wiredly) or wirelessly. According to one embodiment, the interface 377 may include, for example, a high-definition multimedia interface (HDMI), a universal serial bus (USB) interface, a secure digital (SD) card interface, or an audio interface.

A connecting terminal 378 may include a connector via which the electronic device 301 may be physically connected with the external electronic device 302. According to one embodiment, the connecting terminal 378 may include, for example, an HDMI connector, a USB connector, an SD card connector, or an audio connector (e.g., a headphone connector).

The haptic module 379 may convert an electrical signal into a mechanical stimulus (e.g., a vibration or a movement) or an electrical stimulus which may be recognized by a user via tactile sensation or kinesthetic sensation. According to one embodiment, the haptic module 379 may include, for example, a motor, a piezoelectric element, or an electrical stimulator.

The camera module 380 may capture a still image or moving images. According to one embodiment, the camera module 380 may include one or more lenses, image sensors, ISPs, or flashes.

The power management module 388 may manage power supplied to the electronic device 301. The power management module 388 may be implemented as at least part of, for example, a power management integrated circuit (PMIC).

The battery 389 may supply power to at least one component of the electronic device 301. According to one embodiment, the battery 389 may include, for example, a primary cell which is not rechargeable, a secondary cell which is rechargeable, or a fuel cell.

The communication module 390 may support establishing a direct (e.g., wired) communication channel or a wireless communication channel between the electronic device 301 and the external electronic device (e.g., the electronic device 302, the electronic device 304, or the server 308) and performing communication via the established communication channel. The communication module 390 may include one or more CPs that are operable independently from the processor 320 (e.g., the application processor) and supports a direct (e.g., wired) communication or a wireless communication. According to one embodiment, the communication module 390 may include a wireless communication module 392 (e.g., a cellular communication module, a short-range wireless communication module, or a GNSS communication module) or a wired communication module 394 (e.g., a local area network (LAN) communication module or a power line communication (PLC) module). A corresponding one of these communication modules may communicate with the external electronic device via the first network 398 (e.g., a short-range communication network, such as Bluetooth™, wireless-fidelity (Wi-Fi) direct, or a standard of the Infrared Data Association (IrDA)) or the second network 399 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 392 may identify and authenticate the electronic device 301 in a communication network, such as the first network 398 or the second network 399, using subscriber information (e.g., international mobile subscriber identity (IMSI)) stored in the SIM 396.

The antenna module 397 may transmit or receive a signal or power to or from the outside (e.g., the external electronic device) of the electronic device 301. According to one embodiment, the antenna module 397 may include one or more antennas, and, therefrom, at least one antenna appropriate for a communication scheme used in the communication network, such as the first network 398 or the second network 399, may be selected, for example, by the communication module 390 (e.g., the wireless communication module 392). The signal or the power may then be transmitted or received between the communication module 390 and the external electronic device via the selected at least one antenna.

At least some of the above-described components may be mutually coupled and communicate signals (e.g., commands or data) therebetween via an inter-peripheral communication scheme (e.g., a bus, a general purpose input and output (GPIO), a serial peripheral interface (SPI), or a mobile industry processor interface (MIPI)).

According to one embodiment, commands or data may be transmitted or received between the electronic device 301 and the external electronic device 304 via the server 308 coupled with the second network 399. Each of the electronic devices 302 and 304 may be a device of a same type as, or a different type, from the electronic device 301. All or some of operations to be executed at the electronic device 301 may be executed at one or more of the external electronic devices 302, 304, or 308. For example, if the electronic device 301 should perform a function or a service automatically, or in response to a request from a user or another device, the electronic device 301, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 301. The electronic device 301 may provide the outcome, with or without further processing of the outcome, as at least part of a reply to the request. To that end, a cloud computing, distributed computing, or client-server computing technology may be used, for example.

One embodiment may be implemented as software (e.g., the program 340) including one or more instructions that are stored in a storage medium (e.g., internal memory 336 or external memory 338) that is readable by a machine (e.g., the electronic device 301). For example, a processor of the electronic device 301 may invoke at least one of the one or more instructions stored in the storage medium, and execute it, with or without using one or more other components under the control of the processor. Thus, a machine may be operated to perform at least one function according to the at least one instruction invoked. The one or more instructions may include code generated by a complier or code executable by an interpreter. A machine-readable storage medium may be provided in the form of a non-transitory storage medium. The term “non-transitory” indicates that the storage medium is a tangible device, and does not include a signal (e.g., an electromagnetic wave), but this term does not differentiate between where data is semi-permanently stored in the storage medium and where the data is temporarily stored in the storage medium.

According to one embodiment, a method of the disclosure may be included and provided in a computer program product. The computer program product may be traded as a product between a seller and a buyer. The computer program product may be distributed in the form of a machine-readable storage medium (e.g., a compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to one embodiment, each component (e.g., a module or a program) of the above-described components may include a single entity or multiple entities. One or more of the above-described components may be omitted, or one or more other components may be added. Alternatively or additionally, a plurality of components (e.g., modules or programs) may be integrated into a single component. In this case, the integrated component may still perform one or more functions of each of the plurality of components in the same or similar manner as they are performed by a corresponding one of the plurality of components before the integration. Operations, e.g., as illustrated in the flowcharts, performed by the module, the program, or another component may be carried out sequentially, in parallel, repeatedly, or heuristically, or one or more of the operations may be executed in a different order or omitted, or one or more other operations may be added.

Although certain embodiments of the present disclosure have been described in the detailed description of the present disclosure, the present disclosure may be modified in various forms without departing from the scope of the present disclosure. Thus, the scope of the present disclosure shall not be determined merely based on the described embodiments, but rather determined based on the accompanying claims and equivalents thereto.

What is claimed is:

1. A method comprising:
determining, by a graphics processing unit (GPU) processor, an upper threshold number of concurrent program instances and a lower threshold number of concurrent program instances for the GPU processor based on a number of allocations for program variables, a total number of registers of the GPU, and a total number of memory locations of the GPU;
determining, by the GPU processor, a number of concurrent program instances for the GPU processor between the upper threshold number and the lower threshold number, inclusive, that completes allocations for the program variables with corresponding registers and memory locations for a program instance.

2. The method of claim 1, wherein determining the upper threshold number and the lower threshold number comprises:
performing register allocation with unlimited registers to determine the number of allocations for program variables;
determining the upper threshold number based, at least in part, on the number of allocations for program variables, the total number of registers, and the total number of memory locations; and
determining the lower threshold number based, at least in part, on the number of allocations for program variables and the total number of registers.

3. The method of claim 2, wherein determining the number of concurrent program instances comprises:
setting a current number of concurrent program instances to the upper threshold number;
determining a first number of registers and a second number of memory locations per program instance of the current number of concurrent program instances; and
decreasing the current number of concurrent program instances to a next number of concurrent program instances and repeating determining and decreasing steps, wherein the current number is greater than the lower threshold number and the number of allocations cannot be performed with the first number of registers and the second number of memory locations.

4. The method of claim 2, wherein determining the number of concurrent program instances comprises:
setting a current number of concurrent program instances to the upper threshold number;
determining a first number of registers and a second number of memory locations per program instance of the current number of concurrent program instances; and
setting the wave occupancy as the current number of concurrent program instances, wherein the current number is equal to the lower threshold number or the number of allocations can be performed with the first number of registers and the second number of memory locations.

5. The method of claim 4, further comprising:
determining whether the number of allocations can be performed by performing, for the program variables, register allocation with the first number of registers and moving to the second number of memory locations.

6. The method of claim 5, wherein register allocation with unlimited registers and register allocation and moving are performed with different coloring algorithms or a same coloring algorithm.

7. The method of claim 4, wherein determining the first number of registers and the second number of memory locations comprises:
determining the first number of registers per program instance based, at least in part, on the total number of registers and the current number of concurrent program instances; and
determining the second number of memory locations per program instance based, at least in part, on the total number of memory locations and the current number of concurrent program instances.

8. A graphics processing unit (GPU) comprising:
a plurality of registers;
a memory store comprising a plurality of memory locations; and
a processor configured to:
determine an upper threshold number of concurrent program instances and a lower threshold number of concurrent program instances for the processor based on a number of allocations for program variables, a total number of the plurality of registers, and a total number of the plurality of memory locations; and
determine, for the processor, a number of concurrent program instances between the upper threshold number and the lower threshold number, inclusive, that completes allocations for the program variables with corresponding registers and memory locations for a program instance.

9. The GPU claim 8, wherein, in determining the upper threshold number and the lower threshold number, the processor is further configured to:
perform register allocation with unlimited registers to determine the number of allocations for program variables;
determine the upper threshold number based, at least in part, on the number of allocations for program variables, the total number of the plurality of registers, and the total number of the plurality of memory locations; and
determine the lower threshold number based, at least in part, on the number of allocations for program variables and the total number of the plurality of registers.

10. The GPU of claim 9, wherein, in determining the number of concurrent program instances, the processor is further configured to:
set a current number of concurrent program instances to the upper threshold number;
determine a first number of registers and a second number of memory locations per program instance of the current number of concurrent program instances; and
decrease the current number of concurrent program instances to a next number of concurrent program instances and repeating determining and decreasing steps, wherein the current number is greater than the lower threshold number and the number of allocations cannot be performed with the first number of registers and the second number of memory locations.

11. The GPU of claim 9, wherein, in determining the number of concurrent program instances, the processor is further configured to:
set a current number of concurrent program instances to the upper threshold number;
determine a first number of registers and a second number of memory locations per program instance of the current number of concurrent program instances; and
set the wave occupancy as the current number of concurrent program instances, wherein the current number is equal to the lower threshold number or the number of allocations can be performed with the first number of registers and the second number of memory locations.

12. The GPU of claim 11, wherein the processor is further configured to:
determine whether the number of allocations can be performed by performing, for the program variables, register allocation with the first number of registers and moving to the second number of memory locations.

13. The GPU of claim 12, wherein register allocation with unlimited registers and register allocation and moving are performed with different coloring algorithms or a same coloring algorithm.

14. The GPU of claim 11, wherein, in determining the first number of registers and the second number of memory locations, the processor is further configured to:
determine the first number of registers per program instance based, at least in part, on the total number of registers and the current number of concurrent program instances; and
determine the second number of memory locations per program instance based, at least in part, on the total number of memory locations and the current number of concurrent program instances.

15. A user equipment (UE) comprising:
a processor; and
a non-transitory computer readable storage medium storing instructions that, when executed, cause the processor to:
determine an upper threshold number of concurrent program instances and a lower threshold number of concurrent program instances for the processor based on a number of allocations for program variables, a total number of registers of a graphics processing unit (GPU), and a total number of memory locations of the GPU; and
determine, for the processor, a number of concurrent program instances between the upper threshold number and the lower threshold number, inclusive, that completes allocations for the program variables with corresponding registers and memory locations for a program instance.

16. The UE claim 15, wherein, in determining the upper threshold number and the lower threshold number, the instructions further cause the processor to:
perform register allocation with unlimited registers to determine the number of allocations for program variables;
determine the upper threshold number based, at least in part, on the number of allocations for program variables, the total number of the plurality of registers, and the total number of the plurality of memory locations; and
determine the lower threshold number based, at least in part, on the number of allocations for program variables and the total number of the plurality of registers.

17. The UE of claim 15, wherein, in determining the number of concurrent program instances, the instructions further cause the processor to:
set a current number of concurrent program instances to the upper threshold number;
determine a first number of registers and a second number of memory locations per program instance of the current number of concurrent program instances; and
decrease the current number of concurrent program instances to a next number of concurrent program instances and repeating determining and decreasing steps, wherein the current number is greater than the lower threshold number and the number of allocations cannot be performed with the first number of registers and the second number of memory locations.

18. The UE of claim 15, wherein, in determining the number of concurrent program instances, the instructions further cause the processor to:
set a current number of concurrent program instances to the upper threshold number;
determine a first number of registers and a second number of memory locations per program instance of the current number of concurrent program instances; and
set the number of concurrent program instances as the current number of concurrent program instances, wherein the current number is equal to the lower threshold number or the number of allocations can be performed with the first number of registers and the second number of memory locations.

19. The UE of claim 18, wherein the instructions further cause the processor to:
determine whether the number of allocations can be performed by performing, for the program variables, register allocation with the first number of registers and moving to the second number of memory locations.

20. The UE of claim 18, wherein, in determining the first number of registers and the second number of memory locations, the instructions further cause the processor to:
determine the first number of registers per program instance based, at least in part, on the total number of registers and the current number of concurrent program instances; and
determine the second number of memory locations per program instance based, at least in part, on the total number of memory locations and the current number of concurrent program instances.
